(19) United States
(12) Patent Application Publication
(10) Pub. No.: US 2011/0149321 A1
(43) Pub. Date: Jun. 23, 2011

(54) Image forming apparatus and function performing method thereof

(75) Inventors: Myong-hun Cho, Suwon-si (KR); Hyung-ho Lee, Suwon-si (KR)

(73) Assignee: SAMSUNG ELECTRONICS CO., LTD., Suwon (KR)

(21) Appl. No.: 12/926,929

(22) Filed: Dec. 17, 2010

(30) Foreign Application Priority Data
Dec. 21, 2009 (KR) 10-2009-0128227

(51) Int. Cl. G06F 3/12

(52) U.S. Cl. 358/1.13; 358/1.15

(57) ABSTRACT

A function performing method of an image forming apparatus which includes at least one function and is connected to at least one host apparatus, the method including: setting a resources table corresponding to an assignment of resources to at least one function of the image forming apparatus; storing the set resources table; receiving a job command to perform the at least one function; assigning resources to the input function according to the set resources table; performing the function by using the assigned resources, and the function including at least one of scan, copy, print, fax transmission and reception and direct print functions. With this, an image forming apparatus forms a user-defined resources table assigning resources in consideration of a user environment and improves user' satisfaction.

### CROSS-REFERENCE TO RELATED APPLICATIONS

This application claims priority from Korean Patent Application No. 10-2009-0128227, filed on Dec. 21, 2009 in the Korean Intellectual Property Office, the disclosure of which is incorporated herein by reference.

### BACKGROUND

1. Field

Apparatuses and methods consistent with the exemplary embodiments relate to an image forming apparatus and a function performing method thereof, and more particularly, to an image forming apparatus and a function performing method thereof which assigns resources by a user's setting and performs a function.

2. Description of the Related Art

An image forming apparatus forms an image on a document. The image forming apparatus may include a printer, a photocopier, a facsimile, a multi-function device which has at least two functions, etc.

Recently, demand for an image forming apparatus as an office automation device performing not only a document print function but also a scanning function and a faxing function has increased. Accordingly, the image forming apparatus has been developed to provide extended functions with high performance.

As functions of the image forming apparatus vary, the image forming apparatus assigns preset resources to each element and performs a function upon receiving a job command such as copy, fax and Universal Serial Bus (USB) print jobs.

For example, upon reception of the USB print job, the image forming apparatus performs a print job with respect to print data stored in a USB memory by an interface unit communicating with the USB, an image processor forming an image through encoding/decoding operations and an image forming unit generating a hardware signal to output image data received from the image processor.

The image forming apparatus assigns one of hardware resources and software resources to an encoder, a decoder, a scaler and a color converter of the image processor and performs the job.

The hardware resources may include a hardware chip and logic while the software resources may include software programs.

Typically, the image forming apparatus has both the hardware resources and the software resources for elements of the image processor. The hardware resources are high-performance resources which are better processing speed and quality than the software resources.

At the time of designing the device, one of the hardware resources and software resources is assigned and stored in advance to each of the elements for copy, fax, USB print jobs.

For example, in the case of the USB print job, hardware resources may be assigned in advance to the encoder, the decoder, the scaler and the color converter of the image processor.

If a user uses the USB print job more than other jobs, the processing speed of the USB print job may become slow due to the software resources assigned thereto.

That is, a conventional image forming apparatus has the resources assigned at the time of the design and a user cannot help but use the assigned resources. Then, the image forming apparatus does not provide proper performance, and frequently used functions may have a slower processing speed or poor quality, possibly failing to provide proper resources according to various user environments or change of environment.

Further, if the image forming apparatus performs a plurality of jobs and a prior job holds high-performance hardware resources already, a subsequent function may be assigned with software resources even if it requires high quality. Then a user may not be satisfied with the quality.

### SUMMARY

Accordingly, one or more exemplary embodiments provide an image forming apparatus and a function performing method thereof which forms a user-defined resources table and assigning resources to each element for functions in consideration of a user environment and change of environment, assigns the resources to the element according to the formed resources table and performs the function to thereby improve user's satisfaction.

Another exemplary embodiment is to provide an image forming apparatus and a function performing method thereof which selectively reassigns resources depending on resources held by a prior job and optimally utilizes limited resources.

The foregoing and/or other aspects may be achieved by providing a function performing method of an image forming apparatus which includes at least one function and is connected to at least one host apparatus, the method including: setting a resources table corresponding to an assignment of resources to at least one function of the image forming apparatus; storing the set resources table; receiving a job command to perform the at least one function; assigning resources to the input function according to the set resources table; performing the function by using the assigned resources, and the function including at least one of scan, copy, print, fax transmission and reception and direct print functions.

Additional aspects and/or advantages will be set forth in part in the description which follows and, in part, will be apparent from the description, or may be learned by practice of the invention.

The method may further include logging in the image forming apparatus.

The resources table may include at least one of a first resources table corresponding to a user who logs in, and a second resources table which is used in common.

The setting the resources table may include selecting one of an auto mode in which the resources table is automatically set according to a performance factor for the at least one function and a manual mode in which the resources table is set according to a user's selection, and the manual mode may select an application or a non-application of the resource setting for the performance factor.

The auto mode may assign hardware resources to an element corresponding to a job frequently used by a user.

The resources may include at least one of hardware resources and software resources.

The setting the resources table may include assigning the resources to the least one function according to the performance factor, and the performance factor may include a user's preference to at least one of speed, quality and usage frequency, and a high performance factor may be assigned with hardware resources and a low performance factor is assigned with software resources.

The assigning the resources may include determining whether there is an ongoing prior job; and determining whether the prior job may hold the resources according to the resources table if there is the prior job.

The assigning the resources further may include reassigning remaining resources if the prior job holds the resources according to the resources table.

The method may further include setting a performance factor for assigning the resources to each function of the image forming apparatus.

Another aspect is achieved by providing an image forming apparatus which includes at least one function and is connected to at least one host apparatus, the image forming apparatus including: a user input unit which sets a resources table corresponding to an assignment of resources to the at least one function of the image forming apparatus and receives a job command to perform the at least one function; a scan unit which scans a document and generates an image; an image processor which processes an image; an image forming unit which performs a print job; a storage unit which stores therein the set resources table; and a controller which assigns resources to the input function according to the set resources table and controls the image processor to perform the function by using the assigned resources, and the function including at least one of scan, copy, print, fax transmission and reception and direct print functions.

The user input unit may perform a log-in process to the image forming apparatus.

The resources table may include at least one of a first resources table corresponding to a user who logs in, and a second resources table which is used in common.

The user input unit may select one of an auto mode in which the resources table is automatically set according to a performance factor for the at least one function and a manual mode in which the resources table is set according to a user's selection, and the manual mode may select an application or a non-application of the resources setting for the performance factor.

The auto mode may assign hardware resources to an element corresponding to a job frequently used by a user.

The resources may include at least one of hardware resources and software resources.

The user input unit may set the resources table by assigning the resources to the least one function according to the performance factor, and the performance factor may include a user's preference to at least one of speed, quality and usage frequency, and a high performance factor is assigned with hardware resources and a low performance factor is assigned with software resources.

The image processor may include at least one of an encoder, a decoder, a scaler and a color converter.

The controller may determine whether there is an ongoing prior job, and determine whether to perform a subsequent function by determining whether the prior job holds the resources according to the resources table if there is the prior job.

The controller may reassign remaining resources if the prior job holds the preset resources according to the user-defined resources table.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of an image forming apparatus according to an exemplary embodiment;

FIG. 2 illustrates a log-in screen according to the exemplary embodiment;

FIGS. 3 and 4 illustrate resources setting screens according to the exemplary embodiment;

FIG. 5 is a block diagram of an image processor according to the exemplary embodiment;

FIG. 6 illustrates an example of assigning resources to a plurality of jobs;

FIG. 7 illustrates a performance comparison table illustrating resources assigned according to the exemplary embodiment; and

FIG. 8 is a flowchart of a function performing method according to the exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

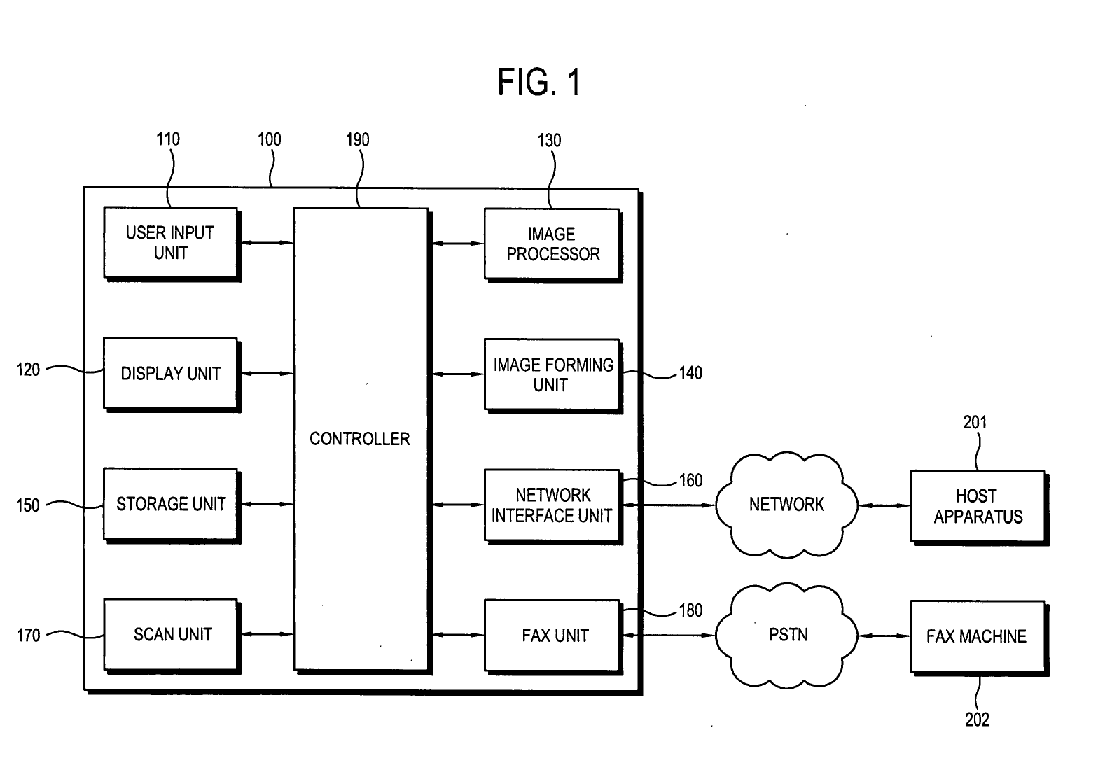

FIG. 1 is a block diagram of an image forming apparatus 100 according to an exemplary embodiment. The image forming apparatus 100 may include a printer, a photocopier, a scanner, a facsimile or a multi-function device having at least two functions.

The image forming apparatus 100 according to the exemplary embodiment assigns resources to each function of the image forming apparatus 100 corresponding to a performance factor such as speed, quality and usage frequency according to a user's setting or user environment, and performs a corresponding function with the assigned resources upon reception of a job command for the function. The function may include at least one of scan, copy, print, fax sending and receiving and direct print (hereinafter, to be also called “USB print”) jobs.

The image forming apparatus 100 may have a multi job performing function to perform a plurality of jobs simultaneously.

As shown in FIG. 1, the image forming apparatus 100 according to the exemplary embodiment includes a user input unit 110, a display unit 120, an image processor 130, an image forming unit 140, a storage unit 150, a network interface unit 160, a scan unit 170, a fax unit 180 and a controller 190.

The user input unit 110 receives a user's command. The user input unit 110 may include an input button (hereinafter, to be also called “hard key”) provided in the image forming apparatus 100 or a graphic user interface (GUI) (hereinafter, to be also called “UI”) which is generated by an execution of a program such as an application and displayed on the display unit 120 to receive a user's input by touch.

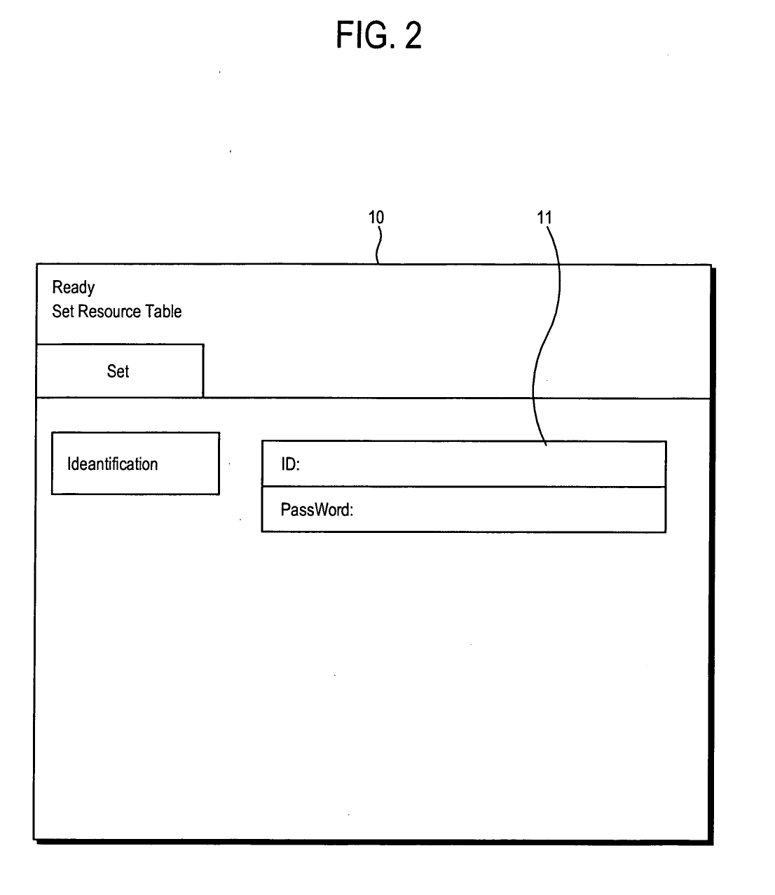

The user input unit 110 includes an icon such as a button, a check box and a text input window as shown in FIGS. 2 to 4.

FIG. 2 illustrates a log-in screen 10 according to the exemplary embodiment.

As shown therein, a user may perform a log-in process inputting an ID and a password 11 assigned for each user account through a UI, as the user input unit 110, displayed on the display unit 120. The log-in process includes an administrator log-in process in which setting and change of all of the environments of the image forming apparatus 100 is available without an additional access limit. If a user log-in process or an administrator log-in process is performed, the image forming apparatus 100 identifies and permits a user. According to the present invention, a user includes an administrator.

The image forming apparatus 100 according to the exemplary embodiment may perform a log-in process from the log-in screen 10 as in FIG. 2 and set a resources table illustrating resources assigned to functions of the image forming apparatus 100.

The set resources table may include at least one of a first resources table corresponding to a user who logs in and a second resources table which is used in common.

An administrator may perform a log-in process in an administrator mode from the log-in screen 10 as in FIG. 2 and set the commonly-used second resources table.

The display unit 120 displays thereon a setting and operation status of the image forming apparatus 100. The display unit 120 may display thereon a UI screen to receive various commands from a user. The display unit 120 may include a liquid crystal display (LCD), a driver (not shown) to drive the LCD, and a touch panel (hereinafter, to be also called “touch screen” or “touch pad”) to recognize a user's touch.

In the image forming apparatus 100, the user input unit 110 may include an icon to be selected by a user through a touch panel of the display unit 120. The user input unit 110 and the display unit 120 may be provided as a single configuration rather than separate configurations.

In the image forming apparatus 100, the single configuration of the user input unit 110 and the display unit 120 is also called an operation panel.

The display unit 120 may include a first display unit which is provided in the image forming apparatus 100 and a second display unit which is provided in a host apparatus 201 connected to the image forming apparatus 100 through the network interface unit 160.

If the display unit 120 includes the second display unit, a remote user interface is selected as the user input unit 110 displayed on the second display unit. A user's command is received from the host apparatus 201 connected to the image forming apparatus 100 through the network interface unit 160.

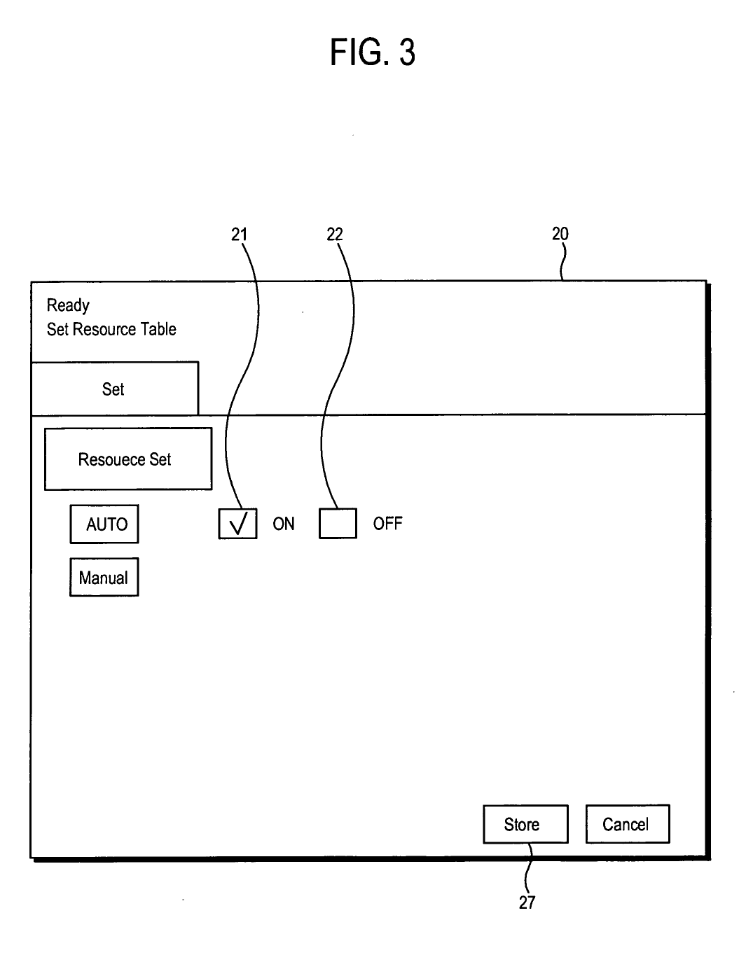

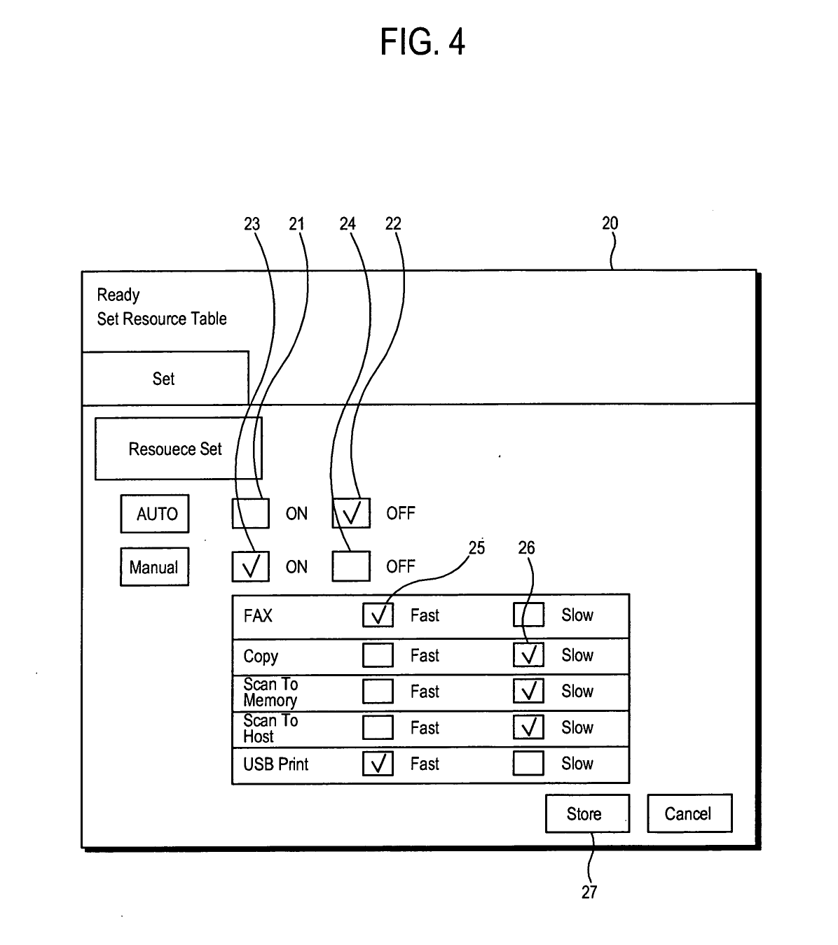

FIGS. 3 and 4 illustrate resources setting screens 20 according to the exemplary embodiment.

If a user performs the log-in process from the log-in screen 10 as in FIG. 2 and selects a resources setting menu, the display unit 120 may display thereon the resources setting screen 20 as in FIG. 3.

The display unit 120 may display thereon the resources setting screen 20 to set the first resources table corresponding to a user who logs in or to set the second resources table corresponding to the log-in performed in the administrator mode and used in common.

The resources include hardware resources and software resources. The hardware resources may include a hardware chip and logic while the software resources may include software programs.

Each element of the image forming apparatus 100 includes both the hardware resources and the software resources. The hardware resources are better in processing speed and quality than the software resources.

A user may select one of on and off check boxes 21 and 22 of an auto mode corresponding to the resources setting screen 20 in FIG. 3 for an automatic setting. The auto mode automatically sets the resources table according to a performance factor of at least one function of the image forming apparatus 100.

If the on check box 21 of the auto mode is selected, the image forming apparatus 100 assigns resources according to a job frequency under a predetermined condition and redefines the resources in the user-defined resources table. The defined resources table is stored in the storage unit 150.

The predetermined condition for setting the job frequency may include recent N times of jobs (e.g. 500 times, 1000 times, etc.) or a job frequency with respect to the total number of jobs during a predetermined period (e.g. 1 month, six months, 1 year, etc.). The image forming apparatus 100 may grant high performance, e.g., may assign the hardware resources to a highly-frequent job.

For example, if a fax job accounts for 50% of jobs performed by the image forming apparatus 100 in the recent one year, the image forming apparatus 100 assigns the hardware resources to the fax job upon selection of the on check box 21 of the auto mode since the fax job is highly frequent.

Accordingly, the image forming apparatus 100 assigns the hardware to the network interface unit 160 transmitting and receiving a fax signal to/from the outside, the image processor 130 processing a received fax signal into an image and the scan unit 170 scanning a document and generating a scan image and performs the fax job.

If the off check box 22 of the auto mode is selected in FIG. 3, the display unit 120 displays thereon a resources setting screen 20 from which a user may set resources according to a predetermined performance factor as in FIG. 4.

The performance factor may employ not only the speed as shown in FIG. 4 but also other various performance factors including quality. In the case of the auto mode in FIG. 3, the usage frequency becomes a performance factor.

A user may select the on check box 23 of a manual mode from the resources setting screen 20 in FIG. 4 and set sources according to a performance factor for each function of the image forming apparatus 100. The manual mode may an application or a non-application of the resources setting for the performance factor.

For example, if a user desires to assign high-performance resources for the fax and USB print job, he/she may select a fast check box 25 for the fax and the USB print jobs and select a slow check box 26 for remaining copy, scan to memory and scan to host jobs.

Thus, the resources may be assigned to each function according to a user's selection. The image forming apparatus 100 may assign the high-performance hardware resources to the fast-set function upon reception of a job command for the function assigned with the resources.

If the performance factor for setting the resources includes quality, the display unit 120 may display thereon high and low check boxes for each job and receive a resources setting from a user.

If the off check boxes 22 and 24 of both the auto and manual modes are checked in the user setting screen 20 in FIG. 4, the preset resources table is maintained.

If the resources setting is completed in FIG. 3 or 4, a user selects a store button 27 and stores in the storage unit 150 resources setting values for each function.

The image processor 130 processes an image to form an image on a document. More specifically, the image processor 130 encodes/decodes, reduces/enlarges, scales and color-converts an image to form a desired image.

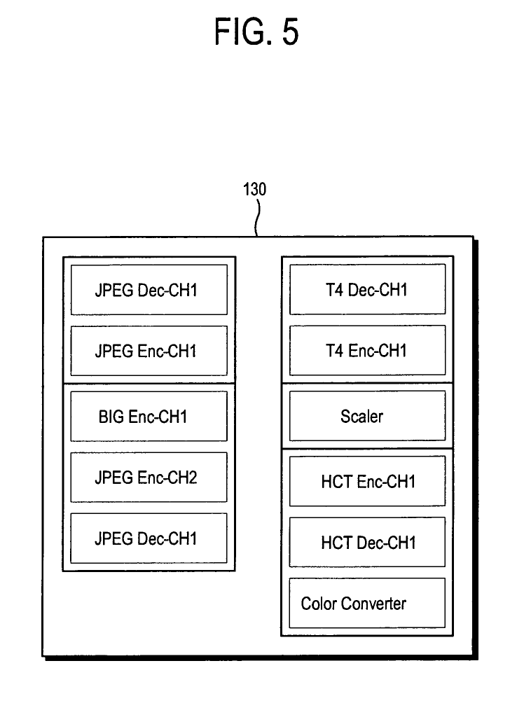

FIG. 5 is a block diagram of the image processor 130 according to the exemplary embodiment.

As shown therein, the image processor 130 includes a plurality of encoders Enc-CH and decoders Dec-CH to compress a received image into a format designated by a user (e.g. JPEG), a scaler, and a color converter to convert a color space. Each of the foregoing elements is supported by the hardware resources and the software resources.

According to the resources setting results in FIG. 3 or 4, each element of the image processor 130 is assigned with one of the hardware resources and the software sources with respect to each job.

For example, there may be a case when the image forming apparatus 100 simultaneously receives a fax reception command and a scan to memory command while the fax function is assigned with high performance (high speed) and the scan to memory function is assigned with low performance (low speed) as in FIG. 4.

Then, the image forming apparatus 100 decodes the received fax data through the JPEG decoder and scales the fax data through the scaler in consideration of a print size and resolution with respect to an image corresponding to the fax job. The image forming apparatus 100 generates an YNCK image through the color converter and performs the print job. The JPEG decoder, the scaler and the color converter use all the hardware resources.

With respect to an image corresponding to the scan to memory job, the image forming apparatus 100 compresses the scan image in a JPEG format through the JPEG encoder and stores the scan image in the storage unit 150. The JPEG encoder uses the software resources.

Accordingly, in the image forming apparatus 100, a user may perform the desired fax job at higher speed when he/she performs a plurality of operations simultaneously with limited resources.

The image forming unit 140 generates a hardware signal to form an image with the image data received from the image processor 130 and performs the print job according to the generated hardware signal. The print job includes a print job for received fax data, a print job to copy a scanned document, and a print job for print data received from the outside through the host apparatus 201 including a server or print data stored in an inside (hard disk drive) or outside (USB memory stick) of the image forming apparatus 100. The print job for the print data stored in the outside means a direct print by which data stored in a USB memory or a memory card may be not only printed but also retransmitted through the network interface unit 160.

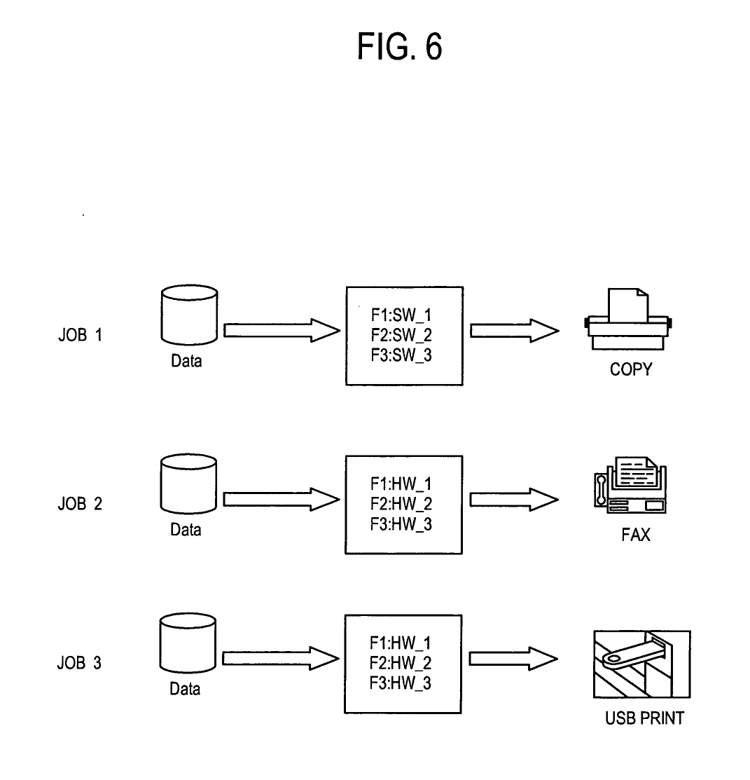

FIG. 6 illustrates an example of assigning resources to a plurality of jobs.

If a user assigns the high-speed hardware resources to the fax and USB print jobs as in FIG. 4 and assigns the low-speed software resources to the copy job, elements F1, F2 and F3 of a job 1 corresponding to the copy job may be assigned with software resources SW_1, SW_2 and SW_3, and elements F1, F2 and F3 of jobs 2 and 3 corresponding to the fax and USB print jobs may be assigned with hardware resources HW_{—1}, HW_2 and HW_3.

A user-defined resources table which illustrates resources assigned to functions of the image forming apparatus 100 is stored in the storage unit 150. If the resources are assigned through a user input process as in FIG. 3 or 4, the user-defined resources table which is prestored in the storage unit 150 is updated.

As described above, the image forming apparatus 100 assigns the hardware resources or the software resources to the functions by using a predetermined performance factor according to a user's preference and performs the function with high performance (e.g. at high speed) for the function highly preferred by a user.

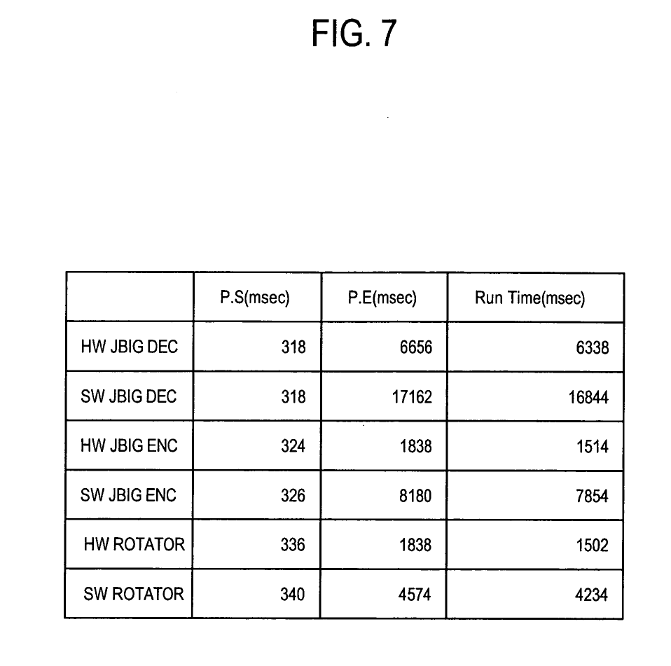

FIG. 7 illustrates a performance comparison table illustrating the resources assigned according to the exemplary embodiment.

As shown therein, comparing a processing start point RS, a processing end point RE and a run time of each type of resources, it may be known that a difference in the run time between the hardware resources and the software resources is up to 10 seconds depending on the type of the resources.

Thus, if resources are assigned according to the performance factor reflecting a user's preference like the image forming apparatus 100 according to the present invention, the performance according to a user's preference may be realized.

The storage unit 150 may store therein various print data for a print job, fax data for a fax transmission, scan data scanned by the scan unit 170, data received from the outside connected through the network interface unit 160, various setting information of the image forming apparatus 100 through the user input unit 110, user registration information set for each user account, user certification information, usage authorization information, resources setting information, etc.

The storage unit 150 includes an internal storage medium such as an HDD 151, or an external or portable storage medium such as a USB memory 152, a memory card (memory stick, CF card, and a MMC), and a memory card slot.

The network interface unit 160 performs a data communication with the host apparatus 201 connected in a wired/wireless network and the outside including a server, and receives print data in a predetermined print language from the outside.

The network interface unit 160 may include a wired/wireless network communication module which is connected with an external device such as the host apparatus 201 by a local connection or in a network by a predetermined protocol, or an interface (e.g., USB port) connected to a portable storage medium such as a USB memory or an interface which is connected to the HDD.

The network interface unit 161 may include a fax communication module (e.g., modem) which converts image data generated by the scan unit 170 into a fax signal and transmits the fax signal to an external fax machine 202 (including a multi-function device having a fax function) by using a public switched telephone network (PSTN) or receives a fax signal from the outside.

The network interface unit 160 may perform a scan to host function or a scan to server function to transmit a scan image to the external device such as the host apparatus 201 or the server by a predetermined protocol or perform a scan to email function to transmit the scan image to the outside.

The data which are received from the outside through the network interface unit 160 (including fax data) are stored in the storage unit 150.

The scan unit 170 scans a document and generates scan data. The document includes a document, a photo, a film, etc. The scan unit 170 may include a photo converter including charge-coupled device (CCD) or contact image sensor (CIS) and an image processor which processes a document into an image by using a signal output by the photo converter. The scan unit 170 may further include a scan motor to drive the photo converter and a guide.

The scan data which are scanned by the scan unit 170 may be converted into a fax signal and transmitted to the external fax machine 202 through the fax unit 180.

The fax unit 180 may include a fax communication module (e.g., modem) which converts image data generated by the scan unit 170 into a fax signal and transmits the fax signal to an external fax machine 202 (including a multi-function device having a fax function) by using a public switched telephone network (PSTN) or receives a fax signal from the external fax machine 202.

The controller 190 controls the image forming apparatus 100 as a whole.

More specifically, the controller 190 stores the setting value in the user-defined resources table of the storage unit 150 if the performance factor for assigning the resources to the functions is set through the user input unit 110.

Upon reception of a command to perform the job of the image forming apparatus 100, the controller 190 loads the preset user-defined resources table from the storage unit 150, and controls the image processor 130 to assign the resources to the elements (e.g. JPEG encoder, scaler and color converter) according to the loaded resources table and to process the image.

The image processor 130 may assign one of the hardware resources and the software resources to the image processing elements according to the loaded user-defined table and process the image.

The controller 190 may determine whether the function may be performed, i.e. whether the image may be processed by assigning the resources according to the loaded resources table.

That is, if a prior job is being performed and already holds the preset resources, the resources may not be assigned according to the loaded resources table.

If the prior job holds the resources as above, the controller 190 determines that the subsequent job may not be performed by assigning the resources according to the preset resources table.

The controller 190 controls the image processor 130 to perform the subsequent job by reassigning the remaining resources.

For example, while the image forming apparatus 100 performs the fax job as the prior job with the user-defined resources table assigning the hardware resources to the fax and USB print jobs, a command to perform the USB print job may be received.

Then, the controller 190 may load the user-defined resources table from the storage unit 150 and determine whether the image may be processed by the resources, i.e., hardware resources assigned to the USB print job.

As the fax job as the prior job holds the hardware resources already, the controller 190 determines that the USB print job may not be performed by using the hardware resources.

Then, the controller 190 controls the image processor 130 to process the image by assigning the software resources which are not held by the USB print job.

While the image forming apparatus 100 performs the copy job as the prior job with the user-defined resources table assigning the software resources to the copy job and the hardware resources to the USB print job, a command to perform the USB print job as the subsequent job may be received.

Then, the controller 190 may load the user-defined resources table from the storage unit 150 and determine whether the image may be processed by the resources, i.e., hardware resources assigned to the USB print job.

As the copy job as the prior job holds the software resources already, the controller 190 determines that the USB print job may be performed by using the hardware resources.

Then, the controller 190 controls the image processor 130 to process the image by reassigning the hardware resources to the USB print job according to the preset user-defined resources table.

Accordingly, the image forming apparatus 100 may selectively reassign the resources depending on the prior job holding the resources and optimally utilize the limited resources to improve user's satisfaction.

Even if the prior job is being performed, for which a user assigns the low-performance resources, the present function may be assigned with the high-performance resources and a user may utilize the image forming apparatus 100 optimally.

The image forming apparatus 100 according to the exemplary embodiment assigns the hardware resources to the jobs requiring the high-performance such as high speed, high quality and high usage frequency. However, the software resources may be assigned to the function requiring the high performance if the assignment of the software resources is more favorable in terms of speed and quality depending on the elements of the image processor 130.

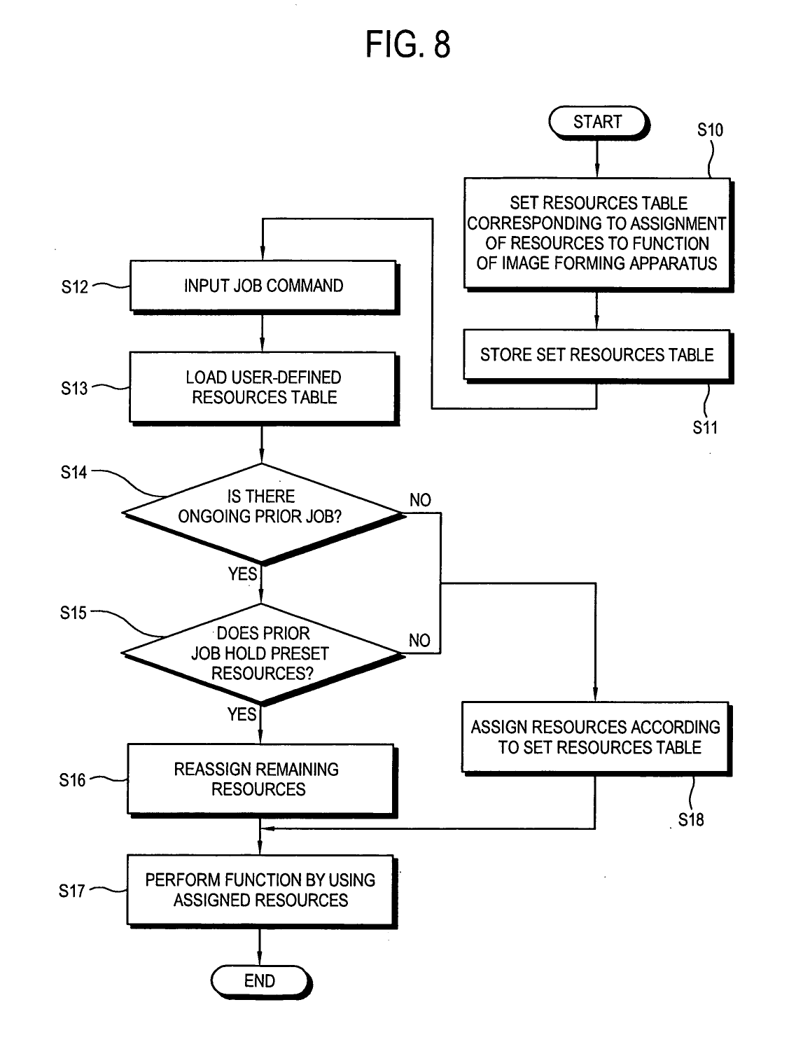

With the foregoing configuration, a process of performing the function of the image forming apparatus 100 will be described with reference to FIG. 8.

FIG. 8 is a flowchart of a function performing method according to the exemplary embodiment.

As shown therein, a user may set the resources table illustrating the resources assigned to the function of the image forming apparatus 100 (S10). A user may set the performance factor to assign the resources to each image processing element. More specifically, a user may select the auto mode from the resources setting screen 20 as in FIG. 3 or select the manual mode from the resources setting screen 20 as in FIG. 4, and the controller 190 may assign and store the resources corresponding to the selected performance factor. The performance factor is user's preference to at least one of speed, quality and usage frequency. The high performance factor may be assigned to the hardware resources while the low performance factor may be assigned to the software resources.

The image forming apparatus 100 stores the set resources table (S11).

The controller 190 may select at least one function of the image forming apparatus 100 and receive a job command to perform the job while the resources table is preset through the resources table setting process (S12).

The controller 190 loads the user-defined resources table from the storage unit 150 corresponding to the command received at operation S12 (S13).

The controller 190 determines whether there is any ongoing prior job (S14).

If it is determined at operation S14 that there is the prior job, the controller 190 determines whether the prior job holds the resources set according to the loaded resources table (S15).

The operations S14 and S15 include an operation of determining whether the function input at operation S12 may be performed by assigning the resources according to the resources table loaded at operation S13.

If it is determined at operation S15 that the prior job holds the preset resources, the controller 190 reassigns the remaining resources (S16).

The controller 190 controls the image processor 130 to perform the function corresponding to the command received at operation S12 by using the resources assigned at operation S16 (S17).

If it is determined at operation S14 that there is no prior job or at operation S15 that the prior job does not hold the preset resources, the controller 190 assigns the resources according to the user-defined resources table loaded at operation S13 (S18).

The controller 190 controls the image processor 130 to perform the function corresponding to the command received at operation S12 by using the resources assigned at operation S18 (S17).

At operation S17, the image forming apparatus 100 selectively reassigns the resources and performs the job according to the determination results at operations S13 and S14.

As described above, an image forming apparatus and a function performing method thereof according to the present invention forms a user-defined resources table assigning resources to each element for functions of the image forming apparatus in consideration of a user environment and change of the environment, assigns resources according to the formed resources table and performs the job to improve user' satisfaction.

Also, the image forming apparatus and the function performing method thereof according to the present invention selectively reassigns the resources depending on a prior job holding the resources and optimally utilizes the limited resources.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A function performing method of an image forming apparatus which comprises at least one function and is connected to at least one host apparatus, the method comprising:
setting a resources table corresponding to an assignment of resources to at least one function of the image forming apparatus;
storing the set resources table;
receiving a job command to perform the at least one function;
assigning resources to the input function according to the set resources table; and
performing the function by using the assigned resources,
the function comprising at least one of scan, copy, print, fax transmission and reception and direct print functions.

2. The method according to claim 1, further comprising logging in the image forming apparatus.

3. The method according to claim 2, wherein the resources table comprises at least one of a first resources table corresponding to a user who logs in, and a second resources table which is used in common.

4. The method according to claim 1, wherein the setting the resources table comprises selecting one of an auto mode in which the resources table is automatically set according to a performance factor for the at least one function and a manual mode in which the resources table is set according to a user's selection, and
the manual mode selects an application or a non-application of the resource setting for the performance factor.

5. The method according to claim 4, wherein the auto mode assigns hardware resources to an element corresponding to a job frequently used by a user.

6. The method according to claim 1, wherein the resources comprise at least one of hardware resources and software resources.

7. The method according to claim 6, wherein the setting the resources table comprises assigning the resources to the least one function according to the performance factor, and the performance factor comprises a user's preference to at least one of speed, quality and usage frequency, and a high performance factor is assigned with hardware resources and a low performance factor is assigned with software resources.

8. The method according to claim 1, wherein the assigning the resources comprises:
determining whether there is an ongoing prior job; and
determining whether the prior job holds the resources according to the resources'table if there is the prior job.

9. The method according to claim 8, wherein the assigning the resources further comprises reassigning remaining resources if the prior job holds the resources according to the resources table.

10. The method according to claim 1, further comprising setting a performance factor for assigning the resources to each function of the image forming apparatus.

11. An image forming apparatus which comprises at least one function and is connected to at least one host apparatus, the image forming apparatus comprising:
a user input unit which sets a resources table corresponding to an assignment of resources to the at least one function of the image forming apparatus and receives a job command to perform the at least one function;
a scan unit which scans a document and generates an image;
an image processor which processes an image;
an image forming unit which performs a print job;
a storage unit which stores therein the set resources table; and
a controller which assigns resources to the input function according to the set resources table and controls the image processor to perform the function by using the assigned resources,
the function comprising at least one of scan, copy, print, fax transmission and reception and direct print functions.

12. The image forming apparatus according to claim 11, wherein the user input unit performs a log-in process to the image forming apparatus.

13. The image forming apparatus according to claim 12, wherein the resources table comprises at least one of a first resources table corresponding to a user who logs in, and a second resources table which is used in common.

14. The image forming apparatus according to claim 11, wherein the user input unit selects one of an auto mode in which the resources table is automatically set according to a performance factor for the at least one function and a manual mode in which the resources table is set according to a user's selection, and
the manual mode selects an application or a non-application of the resources setting for the performance factor.

15. The image forming apparatus according to claim 14, wherein the auto mode assigns hardware resources to an element corresponding to a job frequently used by a user.

16. The image forming apparatus according to claim 11, wherein the resources comprise at least one of hardware resources and software resources.

17. The image forming apparatus according to claim 16, wherein the user input unit sets the resources table by assigning the resources to the least one function according to the performance factor, and
the performance factor comprises a user's preference to at least one of speed, quality and usage frequency, and a high performance factor is assigned with hardware resources and a low performance factor is assigned with software resources.

18. The image forming apparatus according to claim 11, wherein the image processor comprises at least one of an encoder, a decoder, a scaler and a color converter.

19. The image forming apparatus according to claim 11, wherein the controller determines whether there is an ongoing prior job, and determines whether to perform a subsequent function by determining whether the prior job holds the resources according to the resources table if there is the prior job.

20. The image forming apparatus according to claim 19, wherein the controller reassigns remaining resources if the prior job holds the preset resources according to the user-defined resources table.

21. A function performing method of an image forming apparatus which comprises at least one function of scan, copy, print, fax transmission and reception and direct print functions, the method comprising:
forming a user-defined resources table assigning resources to each element for functions of the image forming apparatus in consideration of a user environment and change of the environment;
assigning resources according to the formed resources table; and
performing the function by using the assigned resources.

22. An image forming apparatus which comprises at least one function least one function of scan, copy, print, fax transmission and reception and direct print functions, the image forming apparatus comprising:
an input unit which sets a user-defined resources table assigning resources to each element for functions of the image forming apparatus in consideration of a user environment and change of the environment;
an image processor which processes an image;
an image forming unit which performs a print job;
a controller which assigns resources according to the set resources table and controls the image processor to perform the function by using the assigned resources.
